(19) United States
(12) Patent Application Publication
(10) Pub. No.: US 2005/0221816 A1
(43) Pub. Date: Oct. 6, 2005

(54) System for and method of operating a radio station in a broadcast network

(76) Inventor: Thomas M. Hall, Raleigh, NC (US)

Correspondence Address: BRINKS HOFER GILSON & LIONE, P.O. Box 10395, Chicago, IL, 60610, US

(21) Appl. No.: 10/814,737

(22) Filed: Mar. 31, 2004

(51) Int. Cl. B41M 1/12

(52) U.S. Cl. 455/423

(57) ABSTRACT

A method of operating a radio station in a broadcast network is described. The method comprises the steps of coupling a plurality of radio stations in the broadcast network; enabling each the radio station of the plurality of radio stations to monitor its operating conditions; detecting a fault condition based upon the operating conditions; and communicating the fault condition to a control unit. According to an alternate embodiment, a method comprises the steps of coupling a plurality of radio stations in the broadcast network; receiving a command at a radio station of the plurality of radio stations; and detecting a transmission method for a command received by the radio station. A system for broadcasting a radio signal is also disclosed. The system comprises a central control computer generating a command; a plurality of radio stations coupled to receive the command from the central control computer; a feedback loop between each radio station and the central control computer; and a feedback signal coupled by way of the feedback loop from the radio station to the central control computer, the feedback signal indicating that the command was successfully executed by the radio station.

### FIELD OF THE INVENTION

The present invention relates generally to low power radio stations, and in particular, to a system for and method of operating a radio station in a broadcast network.

### BACKGROUND OF THE INVENTION

Low power AM and low power FM radio stations have been used for years to serve a variety of user needs, both private and public. Such radio stations are sometimes referred to as Highway Advisory Radios, Traveler Information Stations, Low Power FM stations, Community Radio Stations, and Emergency Radio Stations, just to name a few. Such radio stations are sometimes deployed along highways, in state and national parks, at airports, on military bases, or within municipalities. Today, operating licenses for such stations are regulated by the FCC and/or the NTIA, and equipment certifications for the transmitters for these stations are regulated by the FCC.

Several methods have been used in the past for controlling such radio stations. Control functions include, but are not limited to the recording, scheduling, broadcasting, and monitoring of the message content. Some owners of such radio stations deploy multiple stations that are remotely located at field locations. Regardless of the quantity of stations deployed, the control of such radio stations is typically performed in one of several ways, including: local control at each field location via a telephone handset installed in the field, remote control via any touchtone telephone in the world (landline or cellular), or remote control via a computer. In the case of remote control by computer, the method of control can be over a standard analog telephone line using DTMF tones or over a digital serial interface (telephone line or high speed digital network). In general, such radio stations that are controlled by computers use open loop control methods. Specifically, commands are issued, but there is no method for the radio station to provide the necessary feedback to the user that the command was successfully executed.

Accordingly, there is a need for an improved radio station and method of operating a radio station in a broadcast network.

### SUMMARY OF THE INVENTION

A method of operating a radio station in a broadcast network is described. The method comprises the steps of coupling a plurality of radio stations in the broadcast network; enabling each radio station of the plurality of radio stations to monitor its operating conditions; detecting a fault condition based upon the operating conditions; and communicating the fault condition to a control unit. According to an alternate embodiment, a method comprises the steps of coupling a plurality of radio stations in the broadcast network; receiving a command at a radio station of the plurality of radio stations; and detecting a transmission method for the command received by the radio station.

A system for broadcasting a radio signal is also disclosed. The system comprises a central control computer generating a command; a plurality of radio stations coupled to receive the command from the central control computer; a feedback loop between each radio station and the central control computer; and a feedback signal coupled by way of the feedback loop from the radio station to the central control computer, the feedback signal indicating that the command was successfully executed by the radio station.

### BRIEF DESCRIPTION OF THE DRAWINGS

FIG. 1 is a block diagram of a conventional system for controlling a radio station;

FIG. 2 is a system level diagram for controlling a radio station according to the present invention;

FIG. 3 is a block diagram of a system for controlling a radio station according to an embodiment of the present invention;

FIG. 4 is a block diagram of a system for controlling a radio station according to an alternate embodiment according to the present invention;

FIG. 5 is a block diagram of a system for providing user notification according to an embodiment according to the present invention;

FIG. 6 is a block diagram of a radio station according to the present invention;

FIG. 7 is a flow chart showing a method of operating a digitally controlled radio station according to the present invention;

FIG. 8 is a flow chart showing a method of communicating a fault condition in a broadcast network according to the present invention;

FIG. 9 is a flow chart showing a method of providing a feedback signal in a broadcast network according to the present invention; and

FIG. 10 is a flow chart showing a method of determining a transmission method in a broadcast network according to the present invention.

### DETAILED DESCRIPTION OF THE DRAWINGS

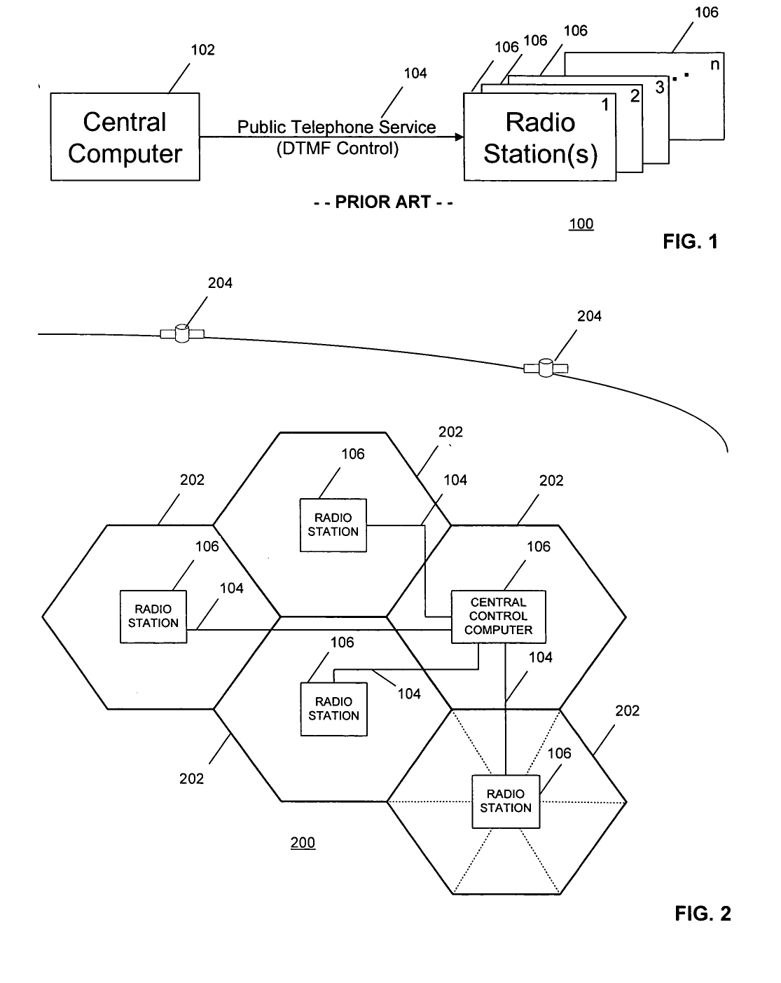

Turning first to FIG. 1, a block diagram of a conventional system for controlling a radio station is shown. In particular, a central computer provides signals and other commands by a predetermined protocol, such as dual-tone multi-frequency (DTMF) signals by way of a communication channel 104 such as a public switched telephone network (PSTN) to a plurality of radio stations 106. However, the central computer does not receive any indication that a radio station is not operating properly.

Turning now to the system level diagram FIG. 2, the plurality of radio stations 106 are distributed in predetermined regions to cover a plurality of regions 204 according the one aspect of the present invention. The central computer 106 and/or the radio stations 106 are also adapted to receive signals from a satellite system, such as a global positioning satellite system having a plurality of satellites 206.

In some deployments, it is desirable for a network of radio stations to be deployed with a synchronized broadcast to extend the coverage area. A synchronous broadcast from multiple stations requires two key ingredients: (1) transmitters that operate at precisely the same frequency, and (2) a single audio source. For the single audio source, a common implementation is to establish one master audio source that feeds the audio signal to multiple radio stations. The link between the master location and the multiple slave radio stations is commonly implemented using Radio Transmission (RT) circuits (provided by the local telephone service provider). These are sometimes referred to as dedicated telephone lines or “always on” telephone lines. Typically, it is necessary for the radio stations to be serviced by the same telephone service provider. To achieve an acceptable broadcast quality, the telephone service provider must inject the appropriate timing delay(s) in the audio signal to each radio station, such that the audio will be delivered to all radio stations within a tolerance of ±1 millisecond. While this approach works well from a technical standpoint, the telephone service providers charge a recurring monthly charge for the RT circuit to each radio station, which can be quite expensive depending on the geographic area and the number of radio stations.

For the transmitter operating frequency, precision adjustable oscillators are often used, but oscillators will drift over time at different rates which will degrade the quality of the broadcast in areas where two or more transmitters have overlapping coverage. Another approach is to use a highly accurate external timing source to drive the transmitter frequency. For example, the highly accurate timing signals from the Global Positioning System (GPS) can be used to reduce the effects from drifting. The system of the present invention preferably has the ability to not only use the accurate timing signals from the GPS, but to also lock the transmitter frequency to the one pulse per second GPS timing signal. Of particular significance is the fact that the system not only results in the exact same frequency for each transmitter but also ensures that the resulting transmitter signals remain in phase with the GPS timing signal. Further, the system provides the user the capability to adjust the phase angle of each transmitter frequency to fine tune the signal, resulting in a much higher quality audio broadcast.

The system preferably provides a synchronized radio broadcast from multiple radio stations without the need for an RT circuit or any other communication method from a master audio source to the slave radio stations. The highly accurate timing signals from the GPS are used to accurately set the time at each radio station. Further, the audio message(s) are preferably recorded in a digital format of a precise length.

By carefully keeping track of the system's timing needs, the broadcast for each radio station is launched at precisely the right time to create the synchronous broadcast. Finally, the invention provides the capability for additional radio stations to be added to the synchronized network of radios that are already broadcasting by carefully managing the systems' timing functions.

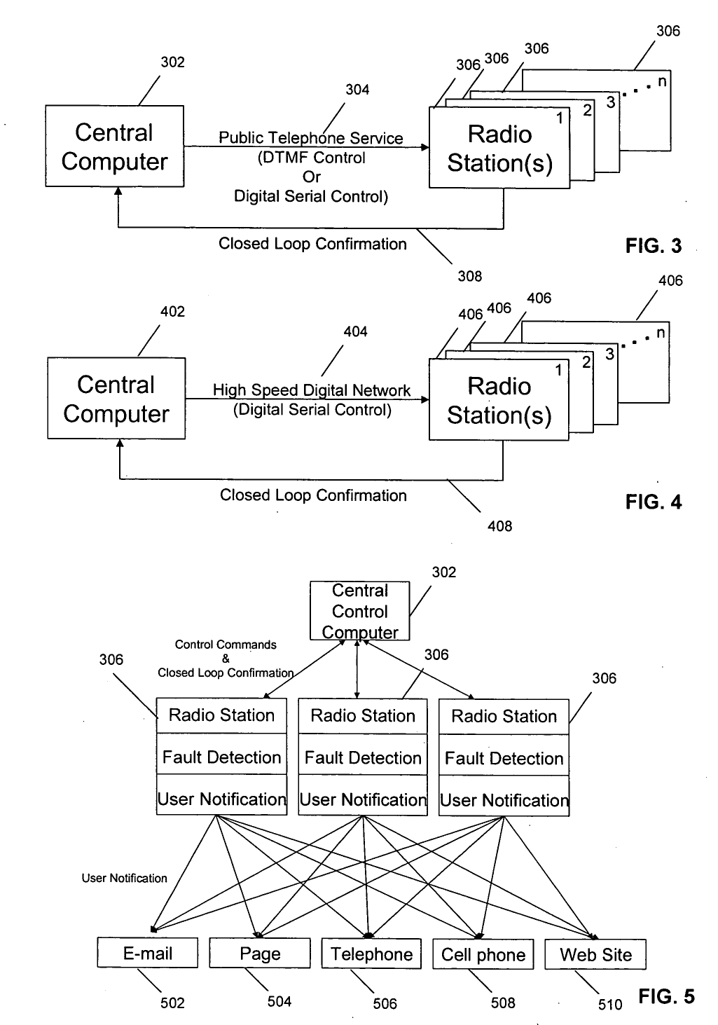

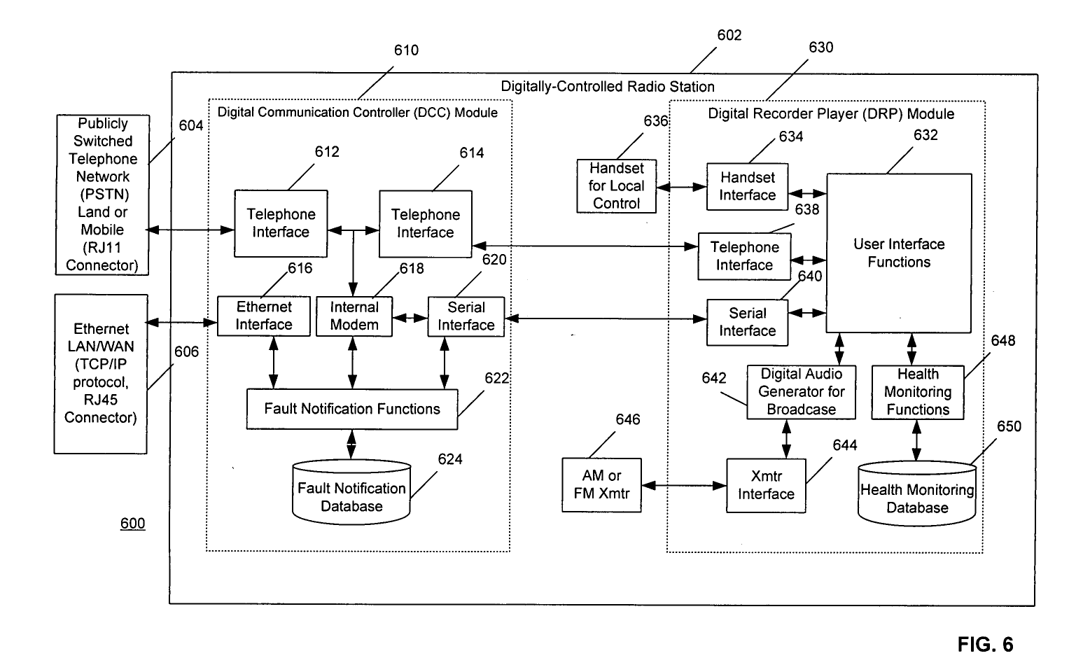

Turning now to FIG. 3, a block diagram of system for controlling a radio station according to an embodiment of the present invention is shown. In particular, a central computer 302 is coupled by a communication channel 304 by way of a public telephone service, such as a public switched telephone network, to a plurality of radio stations 306. The central computer could be, for example, a stand alone PC or server running on any network. Although the embodiments of the present invention are described in reference to a plurality of radio stations, the systems and methods of the present invention could be employed with a single radio station. The communication channel could provide DTMF control signals or digital serial control signals to the plurality of radio stations 306. According to one aspect of the invention, a feedback loop 308 enables feedback signals to be provided to the central computer, as described in more detail in reference to FIG. 5. According to an alternate embodiment according to the present invention in FIG. 4, a central computer 402 is coupled by a communication channel 404 by way of a high speed digital network 404 providing digital serial control signals to a plurality of radio stations. The operation of the radio stations will be described in more detail in reference to FIG. 6.

The radio stations of the embodiments of FIGS. 3 and 4 are accessed via telephone service and, unlike conventional radio stations, are equipped to automatically determine whether the control method is DTMF tones or digital serial commands and then automatically adapt to the method in use at that time and successfully execute the commands and respond to the user. Additionally, each radio station of the embodiments of FIGS. 3 and 4 provides the capability to monitor itself and report its health status to the user. Upon detection of a fault condition, the radio stations automatically alert multiple users of the condition(s), as will be described in more detail in reference to FIG. 5.

Turning now to FIG. 5, a block diagram of a system for providing user notification according to an embodiment is shown. In particular, the central computer 302 provides control commands by way of the communication channel 304 to the plurality of radio stations 306 and receives closed loop confirmation signals from the radio stations by way of the feedback loop 308. Each radio station comprises fault detection and user notification features which will be described in more detail in reference to FIG. 6.

According to one aspect of the invention, radio stations can send such health and fault status information to users via multiple communication methods including, but not limited to: sending an e mail 502, sending a page 504, calling a landline telephone number 506, calling a cellular telephone number 508, updating a web site 510, and updating a database in central control computer 302, such as software running in a PC environment. This invention is embodied in a digitally controlled radio station described in more detail in reference to FIG. 6 that includes the electronics, firmware, and software to provide the capabilities identified above. Although the block diagram of FIG. 5 is described in reference to the embodiment of FIG. 3, the system could also apply to the embodiment of FIG. 4.

Turning now to FIG. 6, a block diagram of a radio station according to the present invention is shown. In particular, a digitally controlled radio station 602 is coupled to a publicly switched telephone network 604 or an Ethernet LAN/WAN 606. A digital communications controller (DCC) module 610 comprises a telephone interface 612 coupled to the publicly switched telephone network 604 and is coupled to a separate telephone interface 614 enabling communication with other portions of the digitally controlled radio station. The digital communications controller module 610 also comprises an Ethernet interface 616 and an internal modem 618 and a serial interface 620, each of which is coupled to a fault notification function block 622 and a fault notification database 624. The internal modem 618 is also connected to the telephone interface 612 and the serial interface 620. The serial interface also enables communication with other portions of the digitally controlled radio station, such as by providing a RS-232 serial connection using a standard DB9 connector.

The digitally controlled radio station further comprises a digital recorder player (DRP) module 630 having a user interface function block 632. The user interface function block 632 is coupled to a handset interface 634 and handset 636 to provide local control. The digital recorder player module 630 further comprises a telephone interface 638 which is adapted to receive signals from the telephone interface 614 of the digital communications controller module 610. The user interface function block 632 is also coupled to a digital audio generator 642 which is coupled to a transmitter interface 644 for generating signals to an AM or FM transmitter 646. Finally, user interface function block 632 is coupled to a digital audio generator 642 and to a health monitoring function block 648 which generates inputs to a health monitoring database 650.

In operation, the digital recorder player module automatically sets a master status flag to FAULT (0) if any of the following status flags is set to FAULT as the result of the corresponding fault condition being detected. The fault conditions could include, for example, an AC Power Status fault, a DC Voltage Status fault, a Broadcast Monitor Status fault, a HAR Mode Status fault, an Outdated Message Status fault. When the master status flag is set to FAULT (0), the digital recorder player module also asserts a hardware fault alert. The circuit of FIG. 6 could be implemented in a digital controlled radio station, such as a radio station having a Digital Communications Controller Module and a DR1500 Digital Recorder Player Module available from Highway Information Systems, Inc., Durham, N.C., USA.

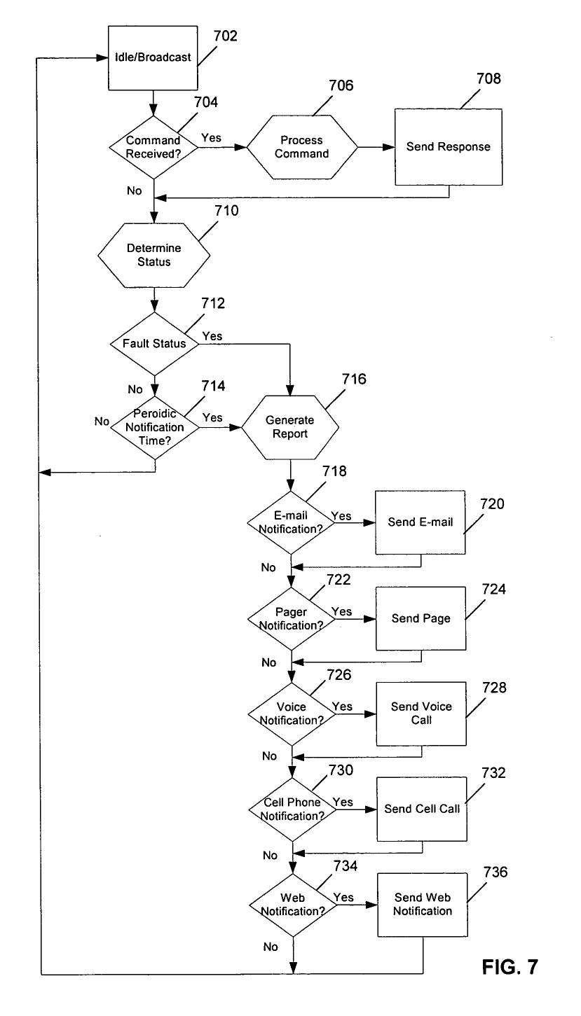

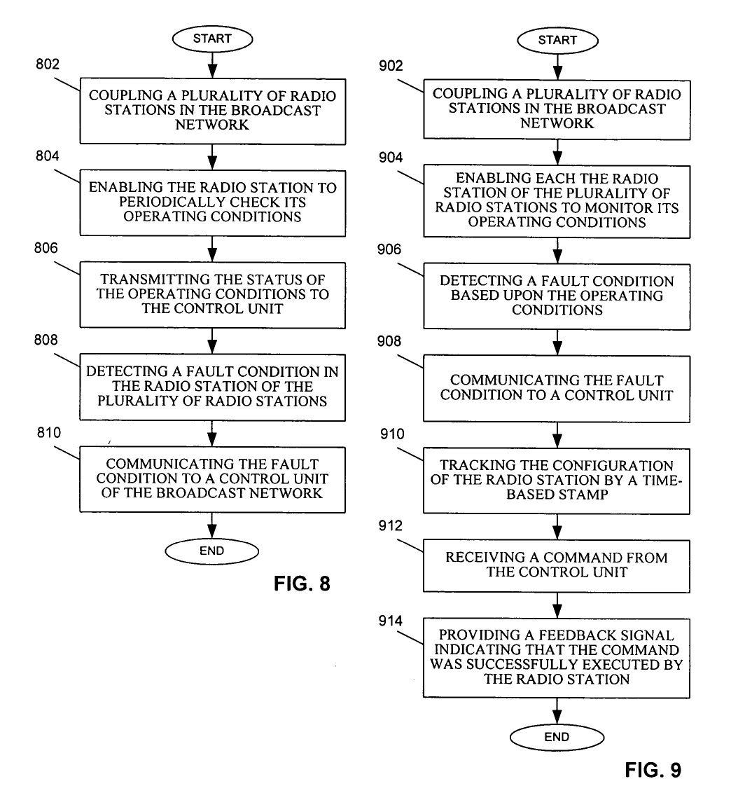

Turning now to FIG. 7, a flow chart shows a method of operating a digitally controlled radio station according to the present invention. The method of FIG. 7, or FIGS. 8-10 described below, could be implemented using the various embodiments of FIGS. 2-6. In particular, a radio station in a broadcast network of radio stations is either in idle or broadcast mode at a step 702. It is then determined whether a command is received at a step 704. If so, the command is processed at a step 706 and a response is sent at a step 708. A fault status is then determined at a step 710. If no fault is detected at a step 712, it is determined whether a periodic time notification has expired at a step 714. If a fault is detected or the periodic notification time has expired, a report is generated at a step 716. The report is then provided by a plurality of notification methods. For example, if an email notification is desired at a step 718, an email is sent at a step 720. If a page notification is desired at a step 722, a page is sent at a step 724. If a voice notification is desired at a step 726, a voice call is made at a step 728. If a cellular telephone notification is desired at a step 730, a cellular telephone call is made at a step 732. Finally, if a web notification is desired at a step 734, a web update is sent at a step 736.

Turning now to FIG. 8, a flow chart shows a method of communicating a fault condition in a broadcast network according to the present invention. In particular, a plurality of radio stations is coupled in the broadcast network at a step 802. The radio stations periodically check their operating conditions at a step 804. The status of the operating conditions is transmitted, preferably by each radio station, to the control unit at a step 806. A fault condition in the radio station of the plurality of radio stations is then detected at a step 808. Finally, the fault condition is communicated to a control unit of the broadcast network at a step 810.

Turning now to FIG. 9, a flow chart shows a method of providing a feedback signal in a broadcast network according to the present invention. In particular, a plurality of radio stations are coupled in the broadcast network at a step 902. Each radio station of the plurality of radio stations is enabled to monitor its operating conditions at a step 904. A fault condition based upon the operating conditions is detected at a step 906. The fault condition is communicated to a control unit at a step 908. The configuration of the radio station is tracked by a time-based stamp at a step 910. A command from the control unit is received at a step 912. Finally, a feedback signal indicating that the command was successfully executed by the radio station is provided at a step 914.

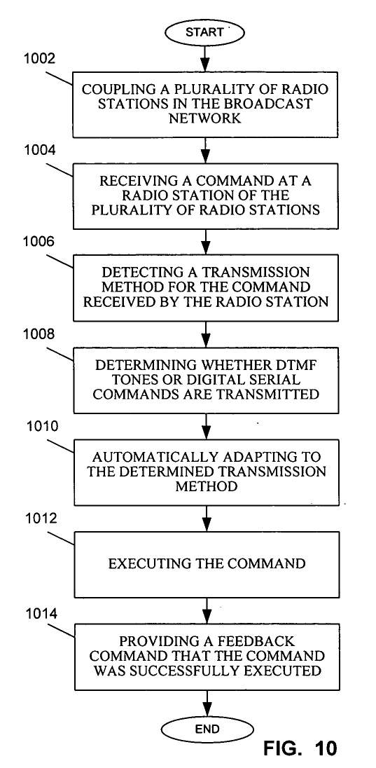

Turning now to FIG. 10, a flow chart shows a method of determining a transmission method in a broadcast network according to the present invention. In particular, a plurality of radio stations is coupled in a broadcast network at a step 1002. A command is received at a radio station of the plurality of radio stations at a step 1004. A transmission method for the command received by the radio station is detected at a step 1006. It is then determined whether DTMF tones or digital serial commands are transmitted at a step 1008. The radio station then automatically adapts to the determined transmission method at a step 1010. The command is then executed at a step 1012, and a feedback command is provided to indicate that the command was successfully executed at a step 1014.

It can therefore be appreciated that the new and novel system and method of operating a radio station has been described. It will be appreciated by those skilled in the art that, particular the teaching herein, numerous alternatives and equivalents will be seen to exist which incorporate the disclosed invention. As a result, the invention is not to be limited by the foregoing embodiments, but only by the following claims.

1. A method of operating a radio station in a broadcast network, said method comprising the steps of:
coupling a plurality of radio stations in said broadcast network;
detecting a fault condition in said radio station of said plurality of radio stations; and
communicating said fault condition to a control unit of said broadcast network.

2. The method of claim 1 wherein said step of communicating said fault condition comprises a step of enabling said radio station to transmit said fault condition to said control unit by a plurality of methods.

3. The method of claim 2 wherein said step of enabling said radio station transmitting said fault condition by a plurality of methods comprises transmitting said fault condition by a plurality of methods from a group consisting of:
sending an email;
sending a page;
calling a telephone number;
updating a web site; and
updating a database in said control unit.

4. The method of claim 1 further comprising a step of enabling said radio station to periodically check its operating conditions.

5. The method of claim 4 further comprising a step of transmitting the status of said operating conditions to said control unit.

6. A method of operating a radio station in a broadcast network, said method comprising the steps of:
coupling a plurality of radio stations in said broadcast network;
enabling each said radio station of said plurality of radio stations to monitor its operating conditions;
detecting a fault condition based upon said operating conditions; and
communicating said fault condition to a control unit.

7. The method of claim 6 wherein said steps of detecting a fault condition comprises detecting a fault condition from a group consisting of:
an AC Power Status faults
a DC Voltage Status fault;
a Broadcast Monitor Status fault;
a HAR Mode Status fault, and
an outdated Message Status fault.

8. The method of claim 6 further comprising a step of tracking the configuration of said radio station by a time-based stamp.

9. The method of claim 6 further comprising a step of receiving a command from said control unit.

10. The method of claim 9 further comprising a step of providing a feedback signal indicating that said command was successfully executed by said radio station.

11. A method of operating a radio station in a broadcast network, said method comprising the steps of:
coupling a plurality of radio stations in said broadcast network;
receiving a command at a radio station of said plurality of radio stations; and
detecting a transmission method for a command received by said radio station.

12. The method of claim 11 wherein said step of detecting a transmission method comprises a step of determining whether DTMF tones or digital serial commands are transmitted.

13. The method of claim 12 further comprising a step of automatically adapting to the determined transmission method.

14. The method of claim 13 further comprising a step of executing said command.

15. The method of claim 14 further comprising a step of providing a feedback command that said command was successfully executed.

16. A system for broadcasting a radio signal, said system comprising:
a central control computer;
a plurality of radio stations coupled to said central control computer; and
a user notification message transmitted by a radio station to said central control computer, said user notification message indicating a fault condition.

17. The system of claim 16 wherein each radio station of said plurality of radio stations comprises a fault detection circuit.

18. The system of claim 16 wherein each radio station of said plurality of radio stations comprises a receiver for receiving control signals from said central control computer.

19. The system of claim 16 further comprising a feedback loop between each said radio station and said central control computer.

20. The system of claim 19 wherein each radio station of said plurality of radio stations comprises a transmitter for coupling a feedback signal by way of said feedback loop from said radio station to said central control computer, said feedback signal indicating that said command was successfully executed by said radio station.

21. A system for broadcasting a radio signal, said system comprising:
a central control computer generating a command;
a plurality of radio stations coupled to receive said command from said central control computer;
a feedback loop between each said radio station and said central control computer; and
a feedback signal coupled by way of said feedback loop from said radio station to said central control computer, said feedback signal indicating that said command was successfully executed by said radio station.

22. The system of claim 21 wherein each radio station of said plurality of radio stations comprises a fault detection circuit.

23. The system of claim 21 wherein each radio station of said plurality of radio stations comprises a receiver for a receiving control signals from said central control computer.

24. The system of claim 21 further comprising a user notification signal generated by said radio station in response to the detection by said radio station of a fault.

25. The system of claim 24 wherein said user notification signal is transmitted by a method from a group consisting of:
sending an email;
sending a page;
calling a telephone number;
updating a web site; and
updating a database in said control unit.

26. A highway advisory radio system comprising:
an interface;
a publicly switched network coupled to the interface;
an amplitude modulating transmitter that encodes information received through the interface using a carrier wave of constant frequency having a varying amplitude;
a controller programmed to manage the information encoded onto the carrier wave; and
digital audio electronics configured to accept an input from a local handset and the controller;
wherein the controller is located away from the amplitude modulating transmitter and the digital audio electronics, and the controller is configured to transmit data using a transmission control protocol and an internet protocol.

27. The highway advisory radio system of claim 26 wherein the digital audio electronics are configured to receive messages expressed through a combination of tones.

28. The highway advisory radio system of claim 27 wherein the digital audio electronics are further configured to receive messages through digital commands.

29. The highway advisory radio system of claim 26 wherein the digital audio electronics are further configured to receive messages through digital commands.

30. The highway advisory radio system of claim 26 further comprising a modulator and a demodulator that enables the controller to communicate across the publicly switched network.

31. The highway advisory radio system of claim 26 wherein the input comprises digitally encoded audio information.

32. The highway advisory radio system of claim 26 wherein the input comprises a plurality of signals having frequencies in a range of perception of a human ear.

33. The highway advisory radio system of claim 26 further comprising a frequency modulation transmitter that encodes information received through the interface.

34. The highway advisory radio system of claim 26 further comprising a synchronizing device that coordinates a communication facilitated through the digital audio electronics with a second communication occurring at a second location.

35. The highway advisory radio system of claim 26 further comprising a synchronizing device that matches a timing of a broadcast transmitted from the amplitude modulating transmitter with a second broadcast transmitted from a second amplitude modulating transmitter located away from the amplitude modulating transmitter.

36. The highway advisory radio system of claim 35 wherein the amplitude modulating transmitter and the second amplitude modulating transmitter broadcast at a common frequency.

37. The high way advisory radio system of claim 35 wherein the synchronizing device is configured to transmit a wireless sync signal.

38. A highway advisory radio system comprising:
an analog interface;
a publicly switched telephone network coupled to the analog interface;
an amplitude modulating transmitter that encodes information received through the analog interface using a carrier wave of constant frequency having a varying amplitude;
a controller programmed to manage the information encoded onto the carrier wave and synchronize a plurality of broadcasts;
digital audio electronics configured to accept an input from a local handset and the controller; and
a modulator and a demodulator that enables the controller to communicate across the publicly switched telephone network;
wherein the controller is located away from the amplitude modulating transmitter.

39. A highway advisory radio system comprising:
an analog interface;
a publicly switched telephone network coupled to the analog interface;
a first amplitude modulating transmitter that encodes information received through the analog interface using a carrier wave of constant frequency having a varying amplitude;
a controller programmed to manage the information encoded onto the carrier wave;
digital audio electronics configured to accept an audio input from a local handset and the controller;
a modulator and a demodulator that enables the controller to communicate across the publicly switched telephone network; and
a synchronizing device configured to synchronize a broadcast from the first amplitude modulating transmitter with a second broadcast transmitted from a second amplitude modulating transmitter;
wherein the controller is located away from the first amplitude modulating transmitter and the digital audio electronics, and the first amplitude modulating transmitter and the second amplitude modulating transmitter are configured to transmit highway advisories.

40. The highway advisory radio system of claim 39 wherein the first amplitude modulating transmitter is located away from the second amplitude modulating transmitter.

41. The highway advisory radio system of claim 39 wherein in the modulator and the demodulator enables the controller to communicate across the publicly switched telephone network in a serial format.

42. The highway advisory radio system of claim 39 wherein the synchronizing device is configured to transmit a sync signal.

43. The highway advisory radio system of claim 39 wherein the controller is programmed to monitor the publicly switched telephone network, the amplitude modulating transmitter, the controller, the digital audio electronics, the modulator and the demodulator, and the synchronizing device.

44. The highway advisory radio system of claim 39 wherein the controller comprises a computer.
